(19) United States
(12) Patent Application Publication
(10) Pub. No.: US 2019/0313635 A1
(43) Pub. Date: Oct. 17, 2019

(54) METHOD FOR PREPARING CUT FLOWER WATER RETENTION AGENT, CUT FLOWER WATER RETENTION AGENT PREPARED THEREBY, AND CUT FLOWER CONTAINER FOR ACCOMMODATING SAME

(71) Applicant: Seung Yeon LEE, Seongnam-si, Gyeonggi-do (KR)

(72) Inventor: Seung Yeon LEE, Seongnam-si, Gyeonggi-do (KR)

(21) Appl. No.: 16/347,645

(22) PCT Filed: Nov. 1, 2017
(86) PCT No.: PCT/KR2017/012224

§ 371 Date: May 6, 2019

(30) Foreign Application Priority Data
Nov. 7, 2016 (KR) 10-2016-0147496

(51) Int. Cl. A01N 3/02; B65D 85/50; B65D 81/24; B65B 25/02

(52) U.S. Cl. CPC A01N 3/02; B65D 85/505; A01G 5/06; B65B 25/023; B65D 81/24

(57) ABSTRACT

The present invention relates to: a method for preparing a cut flower water retention agent; a cut flower water retention agent prepared thereby; and a cut flower container for accommodating the same, and the cut flower water retention agent can supply water and nutrients so as to maintain freshness for a long time without the wilting of cut flowers during the distribution and storage of the cut flowers, and is prepared to be superabsorbent so as to be used by being mixed with water, thereby having convenient use, enabling cut flowers to be safely transported and carried, and enabling a decrease in the commodity value of cut flowers to be prevented during the distribution thereof by extending the lifespan of the cut flowers.

### TECHNICAL FIELD

The present invention relates to a method for preparation of a water retention agent for cut flowers, a water retention agent prepared thereby, and a cut flower container for accommodating the same, more particularly, a method for preparation of a water retention agent for cut flowers which may supply water and nutrients in order to maintain freshness for a long time without wilting of cut flowers during distribution and storage thereof, a water retention agent prepared by the above method, and a cut flower container for accommodating the water retention agent.

### BACKGROUND

Cut flowers are provided for ornaments by gathering flower stalks and, with economic growth in Korea, may occupy substantially 50 to 70% or more of total flower consumption.

Since quality of such cut flowers is influenced by management before and after harvest and, as compared to other crops or plants, a period between maturing and ageing is very short. Therefore, it may be important to maintain constant quality and freshness of the cut flowers.

Recently, due to increase in domestic floriculture farms and increase in production and supply of flowers in flower markets, a price of flowers and flowering plants (commonly ‘flowers’) has decreased, causing farms to turn their attention to foreign countries. Indeed, the price of flowers traded overseas is quite expensive, as much as 10 times the domestic flower price, and therefore, a scale of overseas markets cannot be ignored. For this reason, interest of farmers in exporting flowers is increasing over time, resulting in a trend toward increasing exports.

However, most significant problems in regard to long-distance transportation of flowers may include shortened lifespan of the cut flowers due to environmental factors, intrinsic factors, etc. and the corresponding decrease in commodity value. As such, with increase in exports of flowers, there is a requirement for technical solutions to overcome different problems such as ageing or deterioration in freshness occurring during long-distance transportation.

In particular, floricultural products in flower farms often encounter degradation in quality and a decrease in commodity value of the products during distribution including packaging, transportation and storage after harvest thereof. The product, that is, the cut flowers must maintain the best product state at a desired time point when the consumer wants the product and, if the quality of the product is deteriorated during distribution, the product is not normally sold, instead being discarded, hence causing great economic loss to the flower farms.

Accordingly, industrial demand for extension of a lifespan of cut flowers while preventing a decrease in commodity value is increasing, and a number of studies to meet such industrial demand are ongoing.

For instance, among different methods for restraining a decrease in commodity value of cut flowers, a process for treatment or preservation of cut flowers with a specific solution to extend a lifespan of the cut flowers has been proposed. The specific solution generally refers to a solution for extending the lifespan of cut flowers or a cut flower preservative solution. Such a cut flower preservative solution means a treatment solution capable of improving the quality of cut flowers and extending the lifespan of cut flowers, thereby increasing commodity value of the cut flowers.

The components mentioned above are mostly chemicals to inhibit respiration, transpiration and ageing or suppress growth of microorganisms, however, have difficulties in determining a proper concentration or selecting application time thereof, and are likely to cause stem browning, poor pigmentation of petals, etc.

Further, since the above components exhibit different reaction degrees and effects depending upon types of the cut flowers, it is difficult to use the same in combination. In addition, other problems including relatively short life extension period, a need for separate low-temperature facility and low-temperature transportation facility, pollution exhaustion risk, high price, etc. are also entailed.

Accordingly, in order not only to attain smooth distribution and increasing exports but also to induce activation of domestic markets and increase farmer's incomes, it is requested to develop a material which is economical and easy to use while not causing environmental pollution, thereby reducing an amount of cut flowers discarded due to deterioration in marketability during distribution while supplying high quality cut flowers.

Korean Patent Laid-Open Publication No. 10-2013-0059160 and Korean Patent Laid-Open Publication No. 10-2014-0053582 are introduced as prior documents in the art to which the present invention pertains.

### DISCLOSURE

### Technical Problem

An object of the present invention is to provide a method for preparation of a water retention agent for cut flowers, capable of supplying water and nutrients in order to maintain freshness for a long time without wilting of the cut flowers during distribution and storage thereof, a water retention agent prepared by the above method, and a cut flower container for receiving the same.

Further, another object of the present invention is to provide a method for preparation of a water retention agent for cut flowers, which includes preparing a water absorption water retention agent able to be mixed and used with water, so as to attain advantages of: ease of use; enabling safe delivery and carrying of cut flowers; and enabling lifespan extension of cut flowers to thus prevent a decrease in commodity value thereof during distribution, as well as a water retention agent prepared by the above method and a cut flower container for accommodating the same.

A still further object of the present invention is to provide a method for preparation of a water retention agent for cut flowers, with advantages in that: smooth distribution, increase in exports of cut flowers and activation of domestic markets may be induced, resulting in increase in farmer's income; an amount of the cut flowers discarded due to deterioration in marketability during distribution may be reduced; and best product condition may be retained at a time when consumers want the product, as well as a water retention agent prepared by the above method and a cut flower container for accommodating the same.

Various problems to be solved by the present invention are not particularly limited to the tasks mentioned above, and other problems not mentioned herein will be obviously understood by those skilled in the art from the following description.

### Technical Solution

The method for preparation of a water retention agent for cut flowers according to the present invention may include: preparing a mixed solution by mixing a water-soluble ethylenically unsaturated monomer, a hydrophilic additive and a crosslinking agent in a predetermined ratio by weight (S100); adding a predetermined amount of water to the mixed solution including the water-soluble ethylenically unsaturated monomer, the hydrophilic additive and the crosslinking agent and then stirring the mixed solution (S200); adding a polymerization initiator to the mixed solution including the water-soluble ethylenically unsaturated monomer, the hydrophilic additive and the crosslinking agent, which was obtained after the water addition and stirring process, in order to form a polymer (S300); after drying the polymer, pulverizing the dried polymer to prepare absorbent polymer powder (S400); preparing an additive to be mixed with the absorbent polymer powder in order to supply nutrients to cut flowers (S500); and mixing the absorbent polymer powder and the additive to prepare a water retention agent (S600).

In the preparation of the mixed solution (S100), the water-soluble ethylenically unsaturated monomer may include any one or more selected from a group consisting of: anionic monomers of methacrylic acid, maleic anhydride, crotonic acid, itaconic acid, 2-acryloylethane sulfonic acid, 2-methacryloylethane sulfonic acid, 2-methacryloylpropane sulfonic acid or 2-methacrylamide-2-methyl propane sulfonic acid and salts thereof; and methacrylamide, N-substituted methacrylate, 2-hydroxyethyl methacrylate, 2-hydroxypropyl methacrylate and methoxypolyethyleneglycol methacrylate. Further, the hydrophilic additive may include any one or more selected from a group consisting of sodium dodecyl sulfate, phosphate, sorbitan monolaurate, sorbitan monopalmitate, sorbitan monostearate and sorbitan monooleate. Further, the crosslinking agent may include any one or more selected from a group consisting of N,N′-methylene bismethacrylate, ethylene oxymethacrylate, polyethylene oxymethacrylate, propylene oxymethacrylate, glycerin diacrylate, glycerin triacrylate, trimethylol triacrylate, triallylamine, triaryl cyanurate, triallyl isocyanate, polyethylene glycol, diethylene glycol and propylene glycol. Further, among a total content of the mixed solution including the water-soluble ethylenically unsaturated monomer, the hydrophilic additive and the crosslinking agent, the water-soluble ethylenically unsaturated monomer may be included in an amount of 30 to 60 parts by weight (wt. parts'), the hydrophilic additive may be included in an amount of 5 to 20 wt. parts, and the crosslinking agent may be included in an amount of 1 to 5 wt. parts. Further, in the water addition and stirring process (S200), the water may be added in an amount of 40 to 100 wt. parts to total 100 wt. parts of the mixed solution including the water-soluble ethylenically unsaturated monomer, the hydrophilic additive and the crosslinking agent. Meanwhile, the polymerization initiator may be included in an amount of 0.5 to 3 wt. parts to 100 wt. parts of the water-soluble ethylenically unsaturated monomer. Further, in the polymer drying and pulverization process (S400), the polymer may be dried at a temperature of 80 to 110° C., and the absorbent polymer powder formed by pulverizing the dried polymer may have a particle diameter of 100 to 500 μm.

The additive in the additive preparation process (S500) may be prepared by blending sugar, fungicide, an ethylene inhibitor, a growth regulator and organic acid. More particularly, the additive may be prepared by blending 200 to 300 wt. parts of sugar, 0.5 to 2.0 wt. parts of fungicide, 1 to 3 wt. parts of an ethylene inhibitor, 0.5 to 1.5 wt. parts of a growth regulator and 5 to 10 wt. parts of organic acid. In this regard, the sugar may include any one or more selected from a group consisting of glucose, fructose and sucrose, the fungicide may include any one or more selected from a group consisting of 8-hydroxyquinoline sulfate (8-HQS), 8-hydroxyquinoline citrate (8-HQC), chlorine, aluminum sulfate and sodium hypochlorite (NaClO), the ethylene inhibitor may include silver thiosulfate (STS), the growth regulator may include any one or more selected from magnesium nitrate and calcium chloride, and the organic acid may include any one or more selected from citric acid or ascorbic acid wherein the additive prepared with addition of the organic acid has pH in the range of 3.0 to 3.5. Further, in the additive mixing process (S600), the water retention agent may be prepared by mixing the absorbent polymer powder and the additive in a weight ratio of 9:1 to 6:4.

in addition, the present invention may include a water retention agent for cut flowers, which is prepared according to the present invention.

Further, a cut flower container for accommodating the water retention agent according to the present invention may have an inner case in which the water retention agent is received, wherein the water retention agent is mixed with water and is swollen in the inner case, and the cut flowers are dipped in the water retention agent. The inner case may have a perforated line on a top portion to open the inner case while a fixing tether is provided under the perforated line. The water retention agent may be prepared by the method according to the present invention, which includes: preparing a mixed solution by mixing a water-soluble ethylenically unsaturated monomer, a hydrophilic additive and a crosslinking agent in a predetermined ratio by weight (S100); adding a predetermined amount of water to the mixed solution including the water-soluble ethylenically unsaturated monomer, the hydrophilic additive and the crosslinking agent and then stirring the mixed solution (S200); adding a polymerization initiator to the mixed solution including the water-soluble ethylenically unsaturated monomer, the hydrophilic additive and the crosslinking agent, which was obtained after the water addition and stirring process, in order to form a polymer (S300); after drying the polymer, pulverizing the dried polymer to prepare absorbent polymer powder (S400); preparing an additive to be mixed with the absorbent polymer powder in order to supply nutrients to cut flowers (S500); and mixing the absorbent polymer powder and the additive to prepare a water retention agent (S600). In the preparation of the mixed solution (S100), the water-soluble ethylenically unsaturated monomer may include any one or more selected from a group consisting of: anionic monomers of methacrylic acid, maleic anhydride, crotonic acid, itaconic acid, 2-acryloylethane sulfonic acid, 2-methacryloylethane sulfonic acid, 2-methacryloylpropane sulfonic acid or 2-methacrylamide-2-methyl propane sulfonic acid and salts thereof; and methacrylamide, N-substituted methacrylate, 2-hydroxyethyl methacrylate, 2-hydroxypropyl methacrylate and methoxypolyethyleneglycol methacrylate. Further, the hydrophilic additive may include any one or more selected from a group consisting of sodium dodecyl sulfate, phosphate, sorbitan monolaurate, sorbitan monopalmitate, sorbitan monostearate and sorbitan monooleate. Further, the crosslinking agent may include any one or more selected from a group consisting of N,N′-methylene bismethacrylate, ethylene oxymethacrylate, polyethylene oxymethacrylate, propylene oxymethacrylate, glycerin diacrylate, glycerin triacrylate, trimethylol triacrylate, triallylamine, triaryl cyanurate, triallyl isocyanate, polyethylene glycol, diethylene glycol and propylene glycol. Further, among a total content of the mixed solution including the water-soluble ethylenically unsaturated monomer, the hydrophilic additive and the crosslinking agent, the water-soluble ethylenically unsaturated monomer may be included in an amount of 30 to 60 wt. parts, the hydrophilic additive may be included in an amount of 5 to 20 wt. parts, and the crosslinking agent may be included in an amount of 1 to 5 wt. parts. Further, in the water addition and stirring process (S200), the water may be added in an amount of 40 to 100 wt. parts to total 100 wt. parts of the mixed solution including the water-soluble ethylenically unsaturated monomer, the hydrophilic additive and the crosslinking agent. Meanwhile, the polymerization initiator may be included in an amount of 0.5 to 3 wt. parts to 100 wt. parts of the water-soluble ethylenically unsaturated monomer. Further, in the polymer drying and pulverization process (S400), the polymer may be dried at a temperature of 80 to 110° C., and the absorbent polymer powder formed by pulverizing the dried polymer may have a particle diameter of 100 to 500 μm. The additive in the additive preparation process (S500) may be prepared by blending sugar, fungicide, an ethylene inhibitor, a growth regulator and organic acid. More particularly, the additive may be prepared by blending 200 to 300 wt. parts of sugar, 0.5 to 2.0 wt. parts of fungicide, 1 to 3 wt. parts of an ethylene inhibitor, 0.5 to 1.5 wt. parts of a growth regulator and 5 to 10 wt. parts of organic acid. In this regard, the sugar may include any one or more selected from a group consisting of glucose, fructose and sucrose, the fungicide may include any one or more selected from a group consisting of 8-hydroxyquinoline sulfate (8-HQS), 8-hydroxyquinoline citrate (8-HQC), chlorine, aluminum sulfate and sodium hypochlorite (NaClO), the ethylene inhibitor may include silver thiosulfate (STS), the growth regulator may include any one or more selected from magnesium nitrate and calcium chloride, and the organic acid may include any one or more selected from citric acid and ascorbic acid, wherein the additive prepared with addition of the organic acid has pH in the range of 3.0 to 3.5. Further, in the additive mixing process (S600), the water retention agent may be prepared by mixing the absorbent polymer powder and the additive in a weight ratio of 9:1 to 6:4.

Specific details of other embodiments are included in the description.

### Advantageous Effects

The water retention agent for cut flowers according to the present invention may supply water and nutrients to the cut flowers during distribution and storage, thereby maintaining freshness for a long time without wilting thereof.

Further, the water retention agent for cut flowers according to the present invention is prepared to have high absorption property so that the water retention agent can be mixed and used with water, thereby being easy-to-use, enabling safe delivery and carrying of the cut flowers and enabling lifespan extension of the cut flowers to thus prevent decrease in commodity value of the same during distribution.

Further, the water retention agent for cut flowers according to the present invention may not only attain smooth distribution and an increase in exports, induce activation of domestic markets to thus increase farmer's income, reduce an amount of cut flowers discarded due to deterioration in marketability during distribution, and maintain best product condition at a time when a consumer wants the cut flowers.

It will be understood that embodiments of the present invention may provide diverse effects not specifically mentioned in the description.

### BRIEF DESCRIPTION OF THE DRAWINGS

FIG. 1 is a flowchart illustrating a method for preparation of a water retention agent for cut flowers according to the present invention.

FIGS. 2 and 3 schematically illustrate an inner case of a cut flower container for accommodating the water retention agent for cut flowers according to the present invention.

FIG. 4 schematically illustrates the inner case of the cut flower container for accommodating the water retention agent for cut flowers according to the present invention, wherein the cut flowers are dipped.

### BEST MODE

Advantages and features of the present invention and technical solutions to accomplish the above advantages and features will be obviously understood with reference to the embodiments concretely described below. However, the present invention is not particularly limited to such embodiments and may also be concretely implemented in other different forms. Preferably, the embodiments introduced herein are provided for fully and completely illustrating the subject matters described in the present text and for sufficiently explaining the technical idea of the present invention to those skilled in the art.

The terms used in the present text concretely describe specific embodiments herein, however, the terms are not intended to restrict the present invention. In the specification, singular expressions may also encompass a plural form unless context specifically indicates otherwise.

Unless otherwise defined herein, all terms including technical and scientific terms used in the present text may have the same meanings as commonly understood by those skilled in the art. Further, some terms generally used with typical dictionary definition are duly interpreted to have meanings identical with those stated in the context of the related art and should not be ideally or excessively interpreted unless otherwise clearly and specifically defined.

Hereinafter, the method for preparation of a water retention agent for cut flowers according to the present invention will be described in detail with reference to the accompanying drawings.

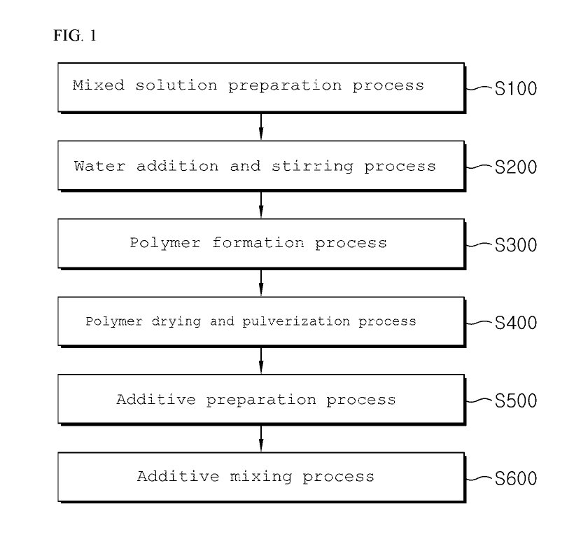

FIG. 1 is a flowchart illustrating a method for preparation of a water retention agent for cut flowers according to the present invention.

Referring to FIG. 1, the method for preparation of a water retention agent for cut flowers according to the present invention may include a mixed solution preparation process (S100), a water addition and stirring process (S200), a polymer formation process (S300), a polymer drying and pulverization process (S400), an additive preparation process (S500) and an additive mixing process (S600).

### 1. Mixed Solution Preparation Step (S100)

The mixed solution preparation step (S100) is a process of mixing a water-soluble ethylenically unsaturated monomer, a hydrophilic additive and a crosslinking agent in a predetermined ratio by weight to prepare the mixed solution.

The water-soluble ethylenically unsaturated monomer used herein may be any common water-soluble ethylenically unsaturated monomer used in an absorbent polymer and include, for example, any one or more selected from a group consisting of: anionic monomers of methacrylic acid, maleic anhydride, crotonic acid, itaconic acid, 2-acryloylethane sulfonic acid, 2-methacryloylethane sulfonic acid, 2-methacryloylpropane sulfonic acid or 2-methacrylamide-2-methyl propane sulfonic acid and salts thereof; and methacrylamide, N-substituted methacrylate, 2-hydroxyethyl methacrylate, 2-hydroxypropyl methacrylate and methoxypolyethyleneglycol methacrylate.

The water-soluble ethylenically unsaturated monomer may be included in an amount of 30 to 60 wt. parts to a total content of the mixed solution including the water-soluble ethylenically unsaturated monomer, the hydrophilic additive and the crosslinking agent. If the amount of the water-soluble ethylenically unsaturated monomer is less than 30 wt. parts, it is difficult to form a polymer. On the other hand, when the above amount exceeds 60 wt. parts, monomers may be agglomerated and thus cause a problem.

After formation of the absorbent polymer, the hydrophilic additive is eluted in the absorbent polymer to form a micro-space inside the same, and absorption of water and nutrients may be increased by the micro-space formed inside the absorbent polymer.

In the present invention, the hydrophilic additive may include any one or more selected from a group consisting of sodium dodecyl sulfate, phosphate, sorbitan monolaurate, sorbitan monopalmitate, sorbitan monostearate and sorbitan monooleate.

In the present invention, the hydrophilic additive may be included in an amount of 5 to 20 wt. parts to a total content of the mixed solution including the water-soluble ethylenically unsaturated monomer, the hydrophilic additive and the crosslinking agent. If less than 5 wt. parts of the hydrophilic additive is used, water absorption is not good. On the other hand, when more than 20 wt. parts of the hydrophilic additive is used, the prepared absorbent polymer may entail a problem of decreased gel strength.

Further, the crosslinking agent is added to maintain an absorption rate of absorbent resin and stable gel strength in a swollen state after absorbing water, and may include, for example, any one or more selected from a group consisting of N,N′-methylene bismethacrylate, ethylene oxymethacrylate, polyethylene oxymethacrylate, propylene oxymethacrylate, glycerin diacrylate, glycerin triacrylate, trimethylol triacrylate, triallylamine, triaryl cyanurate, triallyl isocyanate, polyethylene glycol, diethylene glycol and propylene glycol.

In the present invention, the crosslinking agent may be included in an amount of 1 to 5 wt. parts to a total content of the mixed solution including the water-soluble ethylenically unsaturated monomer, the hydrophilic additive and the crosslinking agent. If less than 1 wt. part of the crosslinking agent is used, gel strength of the prepared absorbent polymer may be too weak despite having excellent water absorption. On the other hand, when more than 5 wt. parts of the crosslinking agent is included, the water absorption may be considerably deteriorated despite having excellent gel strength.

### 2. Water Addition and Stirring Step (S200)

The water addition and stirring step (S200) is a process of adding a predetermined amount of water to the mixed solution prepared by mixing the water-soluble ethylene-base unsaturated monomer, the hydrophilic additive and the crosslinking agent, followed by stirring the mixture.

The water is used to dissolve and disperse the water-soluble ethylenically unsaturated monomer, the hydrophilic additive and the crosslinking agent, and may be added in an amount of 40 to 100 wt. parts to total 100 wt. parts of the mixed solution including the water-soluble ethylenically unsaturated monomer, the hydrophilic additive and the crosslinking agent.

In the present invention, if less than 40 wt. parts of water is included, the amount of water is too little and may cause difficulty in sufficiently dissolving and dispersing the water-soluble ethylenically unsaturated monomer, the hydrophilic additive and the crosslinking agent. On the other hand, when more than 100 wt. parts of water is included, the amount of water is too much and may require a long time to dry the polymer.

### 3. Polymer Formation Step (S300)

The polymer formation step (S300) is a process of adding a polymerization initiator to the mixed solution including the water-soluble ethylenically unsaturated monomer, the hydrophilic additive and the crosslinking agent obtained after the water addition and stirring process, so as to form the polymer.

The polymerization initiator is added to accelerate a reaction of the mixed solution including the water-soluble ethylenically unsaturated monomer, the hydrophilic additive and the crosslinking agent obtained after the water addition and stirring process, and may include, for example, any one or more selected from a group consisting of, benzoin ether, dialkyl acetophenone, hydroxyl alkylketone, phenyl glyoxylate, benzyl dimethyl ketal, acyl phosphine and α-aminoketone, and preferably, 2,4,6-trimethyl-benzoyl-trimethyl phosphine oxide.

In the present invention, the polymerization initiator may be included in an amount of 0.5 to 3 wt. parts to 100 wt. parts of the water-soluble ethylenically unsaturated monomer. If less than 0.5 wt. part of the polymerization initiator is included, a polymerization rate may be reduced due to a low concentration of the polymerization initiator. On the other hand, when more than 3 wt. parts of the polymerization initiator is included, the polymer may entail problems of small molecular weight and non-uniform physical properties.

### 4. Polymer Drying and Pulverizing Step (S400)

The polymer drying and pulverizing step (S400) is a process of drying the polymer and then pulverizing the dried polymer to prepare absorbent polymer powder.

In the polymer drying and pulverizing step (S400), the polymer may be dried at a temperature of 80 to 110° C. If the drying of the polymer is performed at a temperature of less than 80° C., the polymer may be not sufficiently dried. On the other hand, when the drying of the polymer is conducted at a temperature of more than 110° C., physical properties of the absorbent polymer powder are deteriorated and, if pulverizing the polymer in a later process, fine powder may be generated.

Further, in the polymer drying and pulverizing step (S400), the dried polymer may be pulverized by means of a mill such as pin mill, hammer mill, screw mill, roll mill, disc mill or jog mill, wherein the pulverized absorbent polymer powder may be formed to have a particle diameter of 100 to 500 nm.

### 5. Additive Preparation Step (S500)

The additive preparation step (S500) is a process of preparing an additive to be mixed with the absorbent polymer powder, in order to supply nutrients to the cut flowers.

In the additive preparation step (S500), the additive may be prepared by blending sugar, fungicide, an ethylene inhibitor, a growth regulator and organic acid. In particular, 200 to 300 wt. parts of sugar, 0.5 to 2.0 wt. parts of the fungicide, 1 to 3 wt. parts of the ethylene inhibitor, 0.5 to 1.5 wt. parts of the growth regulator and 5 to 10 wt. parts of organic acid may be blended.

The sugar may supply an energy source required for maintenance of biochemical and physiological processes of the cut flowers, in order to prevent the cut flowers from ageing and regulate transpiration of the cut flowers to thus improve moisture imbalance, and promote an increase in water absorption to thus extend lifespan of the cut flowers. The sugar used herein may include any one or more selected from a group consisting of glucose, fructose and sucrose.

The fungicide is used to exterminate saprogenic bacteria and/or pathogens remaining on the cut flowers and may include, for example, any one or more selected from a group consisting of 8-hydroxyquinoline sulfate (8-HQS), 8-hydroxyquinoline citrate (8-HQC), chlorine, aluminum sulfate and sodium hypochlorite (NaClO).

The ethylene inhibitor is used to inhibit generation of a plant hormone, that is, ethylene formed by the cut flowers, wherein the ethylene inhibitor controls ethylene as one of plant hormones during transportation of flowers and flower plants, in order to prevent maturation and ageing of the same, thereby maintaining the best product condition at a time when the consumer wants the product. For instance, the ethylene inhibitor used in the present invention may be silver thiosulfate (STS).

The growth regulator is used to regulate initiation of biochemical and physiological processes of the cut flowers while inhibiting promotion thereof. The growth regulator used herein may include any one or more among magnesium nitrate and calcium chloride.

The magnesium nitrate may be represented by formula of Mg(NO3)2 which is a nitric acid salt of magnesium. The magnesium nitrate may inhibit sulfidation of leaves of the cut flowers, while filling in the stems of the cut flowers to thus prevent generation of microorganisms that shorten the lifespan of the cut flowers, thereby extending the lifespan of the cut flowers.

The calcium chloride is a compound of chlorine and calcium, is moist and has high solubility to water. The calcium chloride may react with pectin forming a cell wall to strengthen the cell wall, inhibit activity of self-pectin degradation enzymes such as polygalacturonase (PG), polymethylglacturonase (PMG), pectinase, β-galactosidase or cellulose, so as to suppress softening of cell tissues and thus prevent entry of pathogens. Further, this compound may also interrupt a production route from methionine to ethylene, thereby preventing the cut flowers from ageing by ethylene.

The organic acid is one of metabolites of substantially all of eukaryotes and may eliminate air bubbles on a stem surface of the cut flower and suppress the growth of bacteria since the organic acid has acidity, and may serve to accelerate water absorption. In the present invention, the organic acid may include any one or more selected from citric acid and ascorbic acid. Adding the organic acid may adjust pH of the additive in the range of 3.0 to 3.5.

According to one embodiment of the present invention, for example, an additive may be prepared by blending sugar, fungicide, an ethylene inhibitor, a growth regulator and an organic acid. However, the technical concept of the present invention is not particularly limited to the aforementioned materials. Preferably, a variety of known functional substances may be further added and it is noted that such substances may be within the scope of the present invention.

### 6. Additive Mixing Step (S600)

The additive mixing step (S600) is a process of mixing the absorbent polymer powder and the additive to prepare a water retention agent.

In the additive mixing step (S600), the absorbent polymer powder may be mixed and coated with the additive to prepare the water retention agent. In this regard, the water retention agent may be prepared by mixing the absorbent polymer powder and the additive in a mixing ratio by weight of 9:1 to 6:4.

According to the present invention, the absorbent polymer powder mixed and coated with the additive as described above is used after adding water thereto so that water and nutrients can be uniformly supplied to cut flowers, and therefore, the cut flowers can be maintained with freshness for a long period of time without being withered during distribution and storage.

Hereinafter, a cut flower container for accommodating the water retention agent for cut flowers according to the present invention will be described in detail with reference to the accompanying drawings.

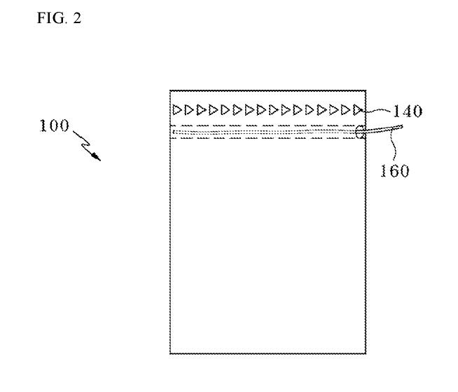

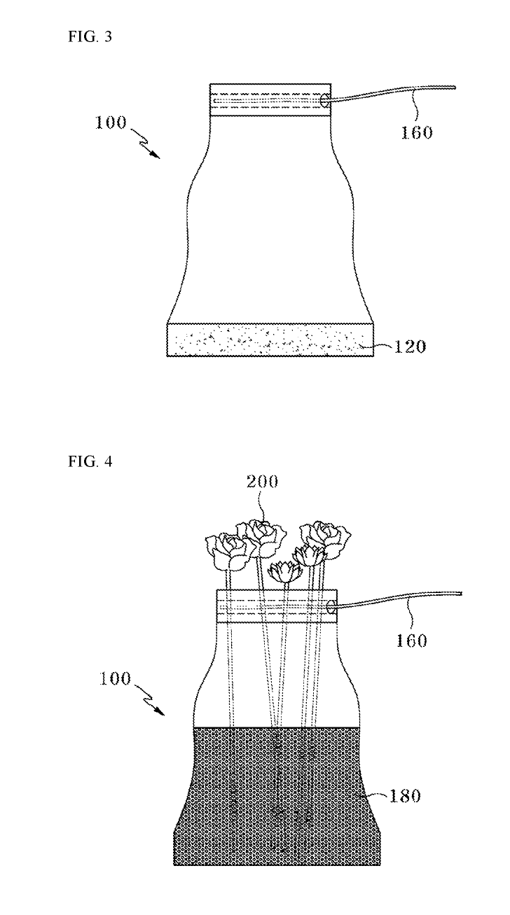

FIGS. 2 and 3 schematically illustrate an inner case of the cut flower container for accommodating the water retention agent for cut flowers according to the present invention, and FIG. 4 schematically illustrates the inner case of the cut flower container for accommodating the water retention agent for cut flowers according to the present invention, wherein the cut flowers are dipped in the water retention agent.

Referring to FIGS. 2 to 4, the cut flower container of the present invention may include an inner case 100 wherein the water retention agent 120 is received, and may be used by dipping the cut flowers 200 in the swollen water retention agent 180 due to water mixed therewith in the inner case 100.

In the inner case 100, the water retention agent 120 mixed and coated with the additive prepared according to the preparation method described above may be received, wherein a perforated line 140 is formed on a top portion of the inner case 100 to open the inner case 100 while a fixing tether 160 may be provided under the perforated line 140.

The inner case 100 may be opened by tearing the top portion along the perforated line 140. More particularly, after tearing the top portion of the inner case 100 along the perforated line 140, the cut flowers 200 may be fixed in the inner case 100 by putting the cut flowers 200 in the inner case 100 and then fixing the top end of the inner case 100 using the fixing tether 160. The inner case 100 may be made from a material such as PP or OPP. In this regard, the material used for forming the inner case 100 is well known in the art and, for convenience and clarity in explanation, a detailed description thereof will be omitted.

In this regard, the cut flowers 200 may be distributed and stored by introducing water into the inner case 100 wherein the water retention agent 120 is received. The water retention agent 120 is swollen in volume by absorbing water (moisture) and, at the same time, retains the water (moisture) therein. The swollen water retention agent 180 due to water mixed thereto may enable constant supply of water and nutrients to the cut flowers 200, thereby maintaining freshness for a long time without wilting of the cut flowers 200.

For instance, the swollen water retention agent 180 due to water mixed therewith has been prepared by mixing the water retention agent 180 with water in an amount of 100 to 120 times the total weight of the absorbent polymer powder mixed and coated with the additive described above, thereby enabling water and nutrients to be supplied to the cut flowers 200 for a long time.

In one embodiment, according to the technical concept of the present invention, in order to protect the inner case 100 wherein the cut flowers 200 are received, an outer case (not shown) may be further provided. Such outer case may protect the inner case 100, wherein the cut flowers 200 are received, from external impact, thereby enabling safe distribution and storage of the cut flowers 200.

In order to protect the inner case 100 made of a soft material, the outer case may be fabricated using any rigid material without restriction. Further, a configuration of the outer case may be differently modified and is well known in the art, and therefore, a detailed description thereof will be omitted.

Hereinafter, the water retention agent for cut flowers according to the present invention will be described in more detail by way of following examples with reference to the accompanying drawings.

### EXAMPLE

First, the water-soluble ethylenically unsaturated monomer, sodium dodecyl sulfate and ethylene oxymethacrylate have been prepared separately. In a relative ratio by weight, 50 wt. parts of the water-soluble ethylenically unsaturated monomer, 10 wt. parts of sodium dodecyl sulfate and 3 wt. parts of ethylene oxymethacrylate were mixed to prepare a mixed solution.

Next, with respect to total 100 wt. parts of the mixed solution, 70 wt. parts of water was introduced, followed by adding 1.5 wt. parts of 2,4,6-trimethyl-benzoyl-trimethyl phosphine oxide as a polymerization initiator thereto to form a polymer. The polymer was dried at a temperature of 95° C. and pulverized using a roll mill, thereby preparing absorbent polymer powder having a particle diameter of 100 to 500 μm.

Thereafter, 250 wt. parts of sucrose, 1 wt. part of 8-hydroxyquinoline sulfate (8-HQS), 2 wt. parts of silver thiosulfate (STS), 0.5 wt. part of magnesium nitrate, 0.5 wt. part of calcium chloride and 7 wt. parts of ascorbic acid were blended to prepare an additive.

Subsequently, the absorbent polymer powder was mixed and coated with the additive in a ratio by weight of 8:2, in order to prepare a water retention agent. After mixing the water retention agent with water of 100 times the weight of the water retention agent and pouring the mixture into a container, cut flowers were dipped in the container.

### Comparative Example 1

According to Comparative Example 1, the absorbent polymer powder was prepared in the same manner as the present inventive example except that the additive prepared by blending sucrose, 8-hydroxyquinoline sulfate, silver thiosulfate, magnesium nitrate, calcium chloride and ascorbic acid was not used to coat the absorbent polymer powder, instead, the absorbent polymer powder only was put in the container, followed by adding water thereto. Then, cut flowers were dipped in the container.

### Comparative Example 2

After preparing an additive in the same content as described in the present inventive example, the additive only was mixed with water and then put in a container. Then, cut flowers were dipped in the container.

With respect to these cut flowers prepared according to the above example and comparative examples, a lifespan of cut flowers (commonly referred to as ‘vase life’) (in days) was monitored.

The vase life (days) was measured on the basis of a time at which the cut flowers left in the container at a temperature of 25° C. were withered to cause a decrease in commodity value of the same.

TABLE 1

| | | Comparative | Comparative |
|---|---|---|---|
| Section | Example | Example 1 | Example 2 |
| Vase life (days) | 7.3 days | 3.6 days | 4.1 days |

Referring to Table 1, the lifespan of the cut flowers according to the present inventive example was 7.3 days and it could be seen that this is longer than the lifespan of the cut flowers according to each of Comparative Example 1 and Comparative Example 2.

Consequently, it is understood that, according to the present inventive example, the absorbent polymer powder mixed and coated with the additive is used after adding water thereto, so as to uniformly supply water and nutrients to cut flowers. As a result, the cut flowers can maintain freshness for a long time without withering.

As described above, a preferred embodiment of the present invention has been described. However, those skilled in the art will appreciate that the present invention may be implemented in other specific forms without altering the technical spirit and/or necessary features thereof. Therefore, the embodiments described above are proposed for illustrative purpose only and may be non-restrictive in every aspect.

### DESCRIPTION OF REFERENCE NUMERALS

100: Inner case

110: Water retention agent

140: Perforated line

160: Fixing tether

180: Swollen water retention agent due to water mixed therewith

200: Cut flowers

1. A method for preparation of a water retention agent for cut flowers, comprising:
preparing a mixed solution by mixing a water-soluble ethylenically unsaturated monomer, a hydrophilic additive and a crosslinking agent in a predetermined ratio by weight (S100);
adding a predetermined amount of water to the mixed solution including the water-soluble ethylenically unsaturated monomer, the hydrophilic additive and the crosslinking agent and then stirring the mixed solution (S200);
adding a polymerization initiator to the mixed solution including the water-soluble ethylenically unsaturated monomer, the hydrophilic additive and the crosslinking agent, which was obtained after the water addition and stirring process, in order to form a polymer (S300);
after drying the polymer, pulverizing the dried polymer to prepare absorbent polymer powder (S400);
preparing an additive to be mixed with the absorbent polymer powder in order to supply nutrients to cut flowers (S500); and
mixing the absorbent polymer powder and the additive to prepare a water retention agent (S600).

2. The method according to claim 1, wherein the water-soluble ethylenically unsaturated monomer used in the mixed solution preparation process (S100) is any one or more selected from a group consisting of: anionic monomers of methacrylic acid, maleic anhydride, crotonic acid, itaconic acid, 2-acryloylethane sulfonic acid, 2-methacryloylethane sulfonic acid, 2-methacryloylpropane sulfonic acid or 2-methacrylamide-2-methyl propane sulfonic acid and salts thereof; and methacrylamide, N-substituted methacrylate, 2-hydroxyethyl methacrylate, 2-hydroxypropyl methacrylate and methoxypolyethyleneglycol methacrylate,
the hydrophilic additive is any one or more selected from a group consisting of sodium dodecyl sulfate, phosphate, sorbitan monolaurate, sorbitan monopalmitate, sorbitan monostearate and sorbitan monooleate,
the crosslinking agent is any one or more selected from a group consisting of N,N′-methylene bismethacrylate, ethylene oxymethacrylate, polyethylene oxymethacrylate, propylene oxymethacrylate, glycerin diacrylate, glycerin triacrylate, trimethylol triacrylate, triallylamine, triaryl cyanurate, triallyl isocyanate, polyethylene glycol, diethylene glycol and propylene glycol,
wherein, among a total content of the mixed solution including the water-soluble ethylenically unsaturated monomer, the hydrophilic additive and the crosslinking agent, the water-soluble ethylenically unsaturated monomer is included in an amount of 30 to 60 parts by weight (‘wt. parts’), the hydrophilic additive is included in an amount of 5 to 20 wt. parts, and the crosslinking agent is included in an amount of 1 to 5 wt. parts,
wherein, in the water addition and stirring process (S200), the water is added in an amount of 40 to 100 wt. parts to total 100 wt. parts of the mixed solution including the water-soluble ethylenically unsaturated monomer, the hydrophilic additive and the crosslinking agent,
wherein the polymerization initiator is included in an amount of 0.5 to 3 wt. parts to 100 wt. parts of the water-soluble ethylenically unsaturated monomer, and wherein, in the polymer drying and pulverization process (S400), the polymer is dried at a temperature of 80 to 110° C., and the absorbent polymer powder formed by pulverizing the dried polymer has a particle diameter of 100 to 500 μm.

3. The method according to claim 1, wherein the additive in the additive preparation process (S500) is prepared by blending sugar, fungicide, an ethylene inhibitor, a growth regulator and organic acid and, in terms of a mixing ratio by weight, the additive is prepared by blending 200 to 300 wt. parts of sugar, 0.5 to 2.0 wt. parts of fungicide, 1 to 3 wt. parts of an ethylene inhibitor, 0.5 to 1.5 wt. parts of a growth regulator and 5 to 10 wt. parts of organic acid,
wherein the sugar is any one or more selected from a group consisting of glucose, fructose and sucrose, the fungicide is any one or more selected from a group consisting of 8-hydroxyquinoline sulfate (8-HQS), 8-hydroxyquinoline citrate (8-HQC), chlorine, aluminum sulfate and sodium hypochlorite (NaClO), the ethylene inhibitor is silver thiosulfate (STS), the growth regulator is any one or more selected from magnesium nitrate and calcium chloride, and the organic acid is any one or more selected from citric acid and ascorbic acid, wherein the additive prepared with addition of the organic acid has pH in the range of 3.0 to 3.5, and
wherein the water retention agent in the additive mixing process (S600) is prepared by mixing the absorbent polymer powder and the additive in a weight ratio of 9:1 to 6:4.

4. (canceled)

5. A cut flower container for accommodating a water retention agent, comprising an inner case that accommodates the water retention agent and is used by dipping the cut flowers in the water retention agent swollen by water present in the inner case and mixed with the water retention agent,
wherein the inner case has a perforated line on a top portion to open the inner case and a fixing tether under the perforated line,
wherein the water retention agent is prepared by a method including:
preparing a mixed solution by mixing a water-soluble ethylenically unsaturated monomer, a hydrophilic additive and a crosslinking agent in a predetermined ratio by weight (S100);
adding a predetermined amount of water to the mixed solution including the water-soluble ethylenically unsaturated monomer, the hydrophilic additive and the crosslinking agent and then stirring the mixed solution (S200);
adding a polymerization initiator to the mixed solution including the water-soluble ethylenically unsaturated monomer, the hydrophilic additive and the crosslinking agent, which was obtained after the water addition and stirring process, in order to form a polymer (S300);
after drying the polymer, pulverizing the dried polymer to prepare absorbent polymer powder (S400);
preparing an additive to be mixed with the absorbent polymer powder in order to supply nutrients to cut flowers (S500); and
mixing the absorbent polymer powder and the additive to prepare a water retention agent (S600),
wherein the water-soluble ethylenically unsaturated monomer used in the mixed solution preparation process (S100) is any one or more selected from a group consisting of: anionic monomers of methacrylic acid, maleic anhydride, crotonic acid, itaconic acid, 2-acryloylethane sulfonic acid, 2-methacryloylethane sulfonic acid, 2-methacryloylpropane sulfonic acid or 2-methacrylamide-2-methyl propane sulfonic acid and salts thereof; and methacrylamide, N-substituted methacrylate, 2-hydroxyethyl methacrylate, 2-hydroxypropyl methacrylate and methoxypolyethyleneglycol methacrylate,
the hydrophilic additive is any one or more selected from a group consisting of sodium dodecyl sulfate, phosphate, sorbitan monolaurate, sorbitan monopalmitate, sorbitan monostearate and sorbitan monooleate,
the crosslinking agent is any one or more selected from a group consisting of N,N′-methylene bismethacrylate, ethylene oxymethacrylate, polyethylene oxymethacrylate, propylene oxymethacrylate, glycerin diacrylate, glycerin triacrylate, trimethylol triacrylate, triallylamine, triaryl cyanurate, triallyl isocyanate, polyethylene glycol, diethylene glycol and propylene glycol,
wherein, among a total content of the mixed solution including the water-soluble ethylenically unsaturated monomer, the hydrophilic additive and the crosslinking agent, the water-soluble ethylenically unsaturated monomer is included in an amount of 30 to 60 wt. parts, the hydrophilic additive is included in an amount of 5 to 20 wt. parts, and the crosslinking agent is included in an amount of 1 to 5 wt, parts,
wherein, in the water addition and stirring process (S200), the water is added in an amount of 40 to 100 wt. parts to total 100 wt. parts of the mixed solution including the water-soluble ethylenically unsaturated monomer, the hydrophilic additive and the crosslinking agent,
wherein the polymerization initiator is included in an amount of 0.5 to 3 wt. parts to 100 wt. parts of the water-soluble ethylenically unsaturated monomer, and
wherein, in the polymer drying and pulverization process (S400), the polymer is dried at a temperature of 80 to 110° C., and the absorbent polymer powder formed by pulverizing the dried polymer has a particle diameter of 100 to 500 μm,
wherein the additive in the additive preparation process (S500) is prepared by blending sugar, fungicide, an ethylene inhibitor, a growth regulator and organic acid and, in terms of a mixing ratio by weight, the additive is prepared by blending 200 to 300 wt. parts of sugar, 0.5 to 2.0 wt. parts of fungicide, 1 to 3 wt. parts of an ethylene inhibitor, 0.5 to 1.5 wt. parts of a growth regulator and 5 to 10 wt. parts of organic acid,
wherein the sugar is any one or more selected from a group consisting of glucose, fructose and sucrose, the fungicide is any one or more selected from a group consisting of 8-hydroxyquinoline sulfate (8-HQS), 8-hydroxyquinoline citrate (8-HQC), chlorine, aluminum sulfate and sodium hypochlorite (NaClO), the ethylene inhibitor is silver thiosulfate (STS), the growth regulator is any one or more selected from magnesium nitrate and calcium chloride, and the organic acid is any one or more selected from citric acid and ascorbic acid, wherein the additive prepared with addition of the organic acid has pH in the range of 3.0 to 3.5, and
wherein the water retention agent in the additive mixing process (S600) is prepared by mixing the absorbent polymer powder and the additive in a weight ratio of 9:1 to 6:4.

6. A water retention agent for cut flowers prepared by:
preparing a mixed solution by mixing a water-soluble ethylenically unsaturated monomer, a hydrophilic additive and a crosslinking agent in a predetermined ratio by weight (S100);
adding a predetermined amount of water to the mixed solution including the water-soluble ethylenically unsaturated monomer, the hydrophilic additive and the crosslinking agent and then stirring the mixed solution (S200);
adding a polymerization initiator to the mixed solution including the water-soluble ethylenically unsaturated monomer, the hydrophilic additive and the crosslinking agent, which was obtained after the water addition and stirring process, in order to form a polymer (S300);
after drying the polymer, pulverizing the dried polymer to prepare absorbent polymer powder (S400);
preparing an additive to be mixed with the absorbent polymer powder in order to supply nutrients to cut flowers (S500); and
mixing the absorbent polymer powder and the additive to prepare a water retention agent (S600).

7. The water retention agent for cut flowers according to claim 1, wherein the water-soluble ethylenically unsaturated monomer used in the mixed solution preparation process (S100) is any one or more selected from a group consisting of: anionic monomers of methacrylic acid, maleic anhydride, crotonic acid, itaconic acid, 2-acryloylethane sulfonic acid, 2-methacryloylethane sulfonic acid, 2-methacryloylpropane sulfonic acid or 2-methacrylamide-2-methyl propane sulfonic acid and salts thereof; and methacrylamide, N-substituted methacrylate, 2-hydroxyethyl methacrylate, 2-hydroxypropyl methacrylate and methoxypolyethyleneglycol methacrylate,
the hydrophilic additive is any one or more selected from a group consisting of sodium dodecyl sulfate, phosphate, sorbitan monolaurate, sorbitan monopalmitate, sorbitan monostearate and sorbitan monooleate,
the crosslinking agent is any one or more selected from a group consisting of N,N′-methylene bismethacrylate, ethylene oxymethacrylate, polyethylene oxymethacrylate, propylene oxymethacrylate, glycerin diacrylate, glycerin triacrylate, trimethylol triacrylate, triallylamine, triaryl cyanurate, triallyl isocyanate, polyethylene glycol, diethylene glycol and propylene glycol,
wherein, among a total content of the mixed solution including the water-soluble ethylenically unsaturated monomer, the hydrophilic additive and the crosslinking agent, the water-soluble ethylenically unsaturated monomer is included in an amount of 30 to 60 parts by weight (‘wt. parts’), the hydrophilic additive is included in an amount of 5 to 20 wt. parts, and the crosslinking agent is included in an amount of 1 to 5 wt. parts,
wherein, in the water addition and stirring process (S200), the water is added in an amount of 40 to 100 wt. parts to total 100 wt. parts of the mixed solution including the water-soluble ethylenically unsaturated monomer, the hydrophilic additive and the crosslinking agent,
wherein the polymerization initiator is included in an amount of 0.5 to 3 wt. parts to 100 wt. parts of the water-soluble ethylenically unsaturated monomer, and wherein, in the polymer drying and pulverization process (S400), the polymer is dried at a temperature of 80 to 110° C., and the absorbent polymer powder formed by pulverizing the dried polymer has a particle diameter of 100 to 500 μm.

8. The water retention agent for cut flowers according to claim 1, wherein the additive in the additive preparation process (S500) is prepared by blending sugar, fungicide, an ethylene inhibitor, a growth regulator and organic acid and, in terms of a mixing ratio by weight, the additive is prepared by blending 200 to 300 wt. parts of sugar, 0.5 to 2.0 wt. parts of fungicide, 1 to 3 wt. parts of an ethylene inhibitor, 0.5 to 1.5 wt. parts of a growth regulator and 5 to 10 wt. parts of organic acid,
wherein the sugar is any one or more selected from a group consisting of glucose, fructose and sucrose, the fungicide is any one or more selected from a group consisting of 8-hydroxyquinoline sulfate (8-HQS), 8-hydroxyquinoline citrate (8-HQC), chlorine, aluminum sulfate and sodium hydrochlorite (NaClO), the ethylene inhibitor is silver thiosulfate (STS), the growth regulator is any one or more selected from magnesium nitrate and calcium chloride, and the organic acid is any one or more selected from citric acid and ascorbic acid, wherein the additive prepared with addition of the organic acid has pH in the range of 3.0 to 3.5, and
wherein the water retention agent in the additive mixing process (S600) is prepared by mixing the absorbent polymer powder and the additive in a weight ratio of 9:1 to 6:4.
